(19) United States
(12) Patent Application Publication
(10) Pub. No.: US 2004/0189710 A1
(43) Pub. Date: Sep. 30, 2004

(54) Technique for displaying a window in a computer screen

(76) Inventors: David L. Goulden, Redwood City, CA (US); Scott G. Eagle, Menlo Park, CA (US); Anthony G. Martin, Los Altos, CA (US)

Correspondence Address: OKAMOTO & BENEDICTO, LLP, P.O. BOX 641330, SAN JOSE, CA, 95164, US

(21) Appl. No.: 10/402,843

(22) Filed: Mar. 28, 2003

(51) Int. Cl. G09G 5/00

(52) U.S. Cl. 345/790

(57) ABSTRACT

The present invention relates to techniques for displaying multiple windows in a networked computer. Embodiments of the invention may be employed in a variety of applications including advertising delivery on the Internet. In one embodiment, an advertising window is displayed by determining an area occupied by a browser window in a computer screen, determining if there is available space to display the advertising window in the computer screen, and displaying the advertising window in an available space if there is one. If there is no available space in the computer screen, the browser window may be reconfigured to make room for the advertising window. The present invention advantageously allows an advertising window to be displayed without substantially overlapping a browser window, thereby minimizing possible end-user confusion as to content source. In addition, the advertising window is displayed with minimal interruption to end-user browsing activity.

### BACKGROUND OF THE INVENTION

1. Field of the Invention

The present invention relates generally to computer systems, and more particularly but not exclusively to methods and apparatus for displaying multiple windows in a networked computer.

2. Description of the Background Art

In some multi-tasking operating systems, such as Microsoft Windows™, Apple Mac OS X™, and various UNIX™-based operating systems, each task or program may have its own bordered region in a computer screen. This bordered region is commonly referred to as a “window”. Multiple windows may be displayed on the same computer screen at the same time. In the Microsoft Windows™ operating system, for example, a spreadsheet program may be displayed in one window while a word processing program may be displayed in another window on the same computer screen.

In a stand-alone computer, identifying the source of a window's content is normally not an issue because windows typically display content provided by their respective programs or an end-user. For example, a word processing window typically displays content generated by the word processing program or entered by an end-user. Thus, in a stand-alone computer, a border and a title bar are usually enough to distinguish one window from another.

The availability of large public networks, such as the Internet, has made identifying the source of a window's content more important. As is well known, a web browser is a program that allows a computer coupled to the Internet to display content provided by a web site. Multiple instances of a web browser may be displayed as separate windows referred to as “browser windows”. That is, one browser window may be pointed to one web site, while another browser window may be pointed to another web site. Although each browser window is readily identifiable as an instance of a particular web browser, the source of the content being displayed in a browser window may be difficult to identify. That is, in some situations, it may be difficult to determine which web site provided the content being displayed in a browser window.

An end-user browsing on the Internet may also encounter various advertising windows. An advertising window may be an instance of a browser window, or a custom window designed to display advertising. Examples of advertising windows include pop-ups, pop-unders, and banners. To attract an end-user's attention, a typical advertising window is designed to be as noticeable as possible. This, however, typically results in the advertising window disrupting the end-user's browsing activity.

### SUMMARY

The present invention relates to techniques for displaying multiple windows in a networked computer. Embodiments of the invention may be employed in a variety of applications including advertising delivery on the Internet.

In one embodiment, an advertising window is displayed by determining an area occupied by a browser window in a computer screen, determining if there is available space to display the advertising window in the computer screen, and displaying the advertising window in an available space if there is one. If there is no available space in the computer screen, the browser window may be reconfigured to make room for the advertising window. The present invention allows an advertising window to be displayed without substantially overlapping a browser window, thereby minimizing possible end-user confusion as to content source. In addition, the advertising window is displayed with minimal interruption to end-user browsing activity.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a browser window and an advertising window displayed in a computer screen.

FIGS. 2A and 2B illustrate an embodiment of the present invention where an advertising window is displayed in an available space in a computer screen.

FIGS. 3A and 3B illustrate an embodiment of the present invention where a browser window is reconfigured to make room for an advertising window.

FIG. 4 shows a flow diagram of a method for displaying an advertising window in a networked computer in accordance with an embodiment of the present invention.

The use of the same reference label in different drawings indicates the same or like components.

### DETAILED DESCRIPTION

In the present disclosure, numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention. For example, the details of receiving information over the Internet and displaying the information in a window are, in general, known in the art and accordingly not described herein.

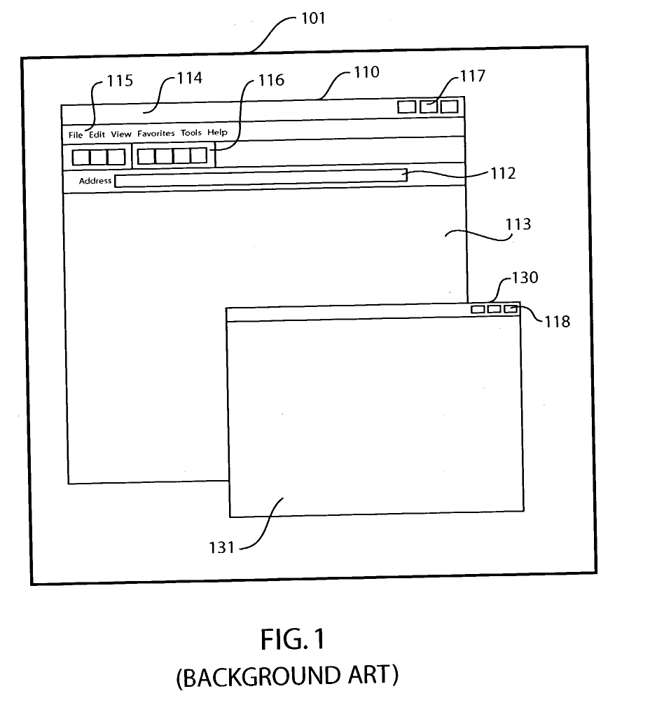

Referring now to FIG. 1, there is shown a browser window 110 being displayed in a display area 101 of a computer screen. The computer screen may comprise a cathode ray tube (CRT), plasma display, TFT screen, liquid crystal display (LCD), and other apparatus for displaying information in a computer. The computer may be a personal computer, a web-enabled telephone, a personal digital assistant, or any wired or wireless apparatus capable of being coupled to a network, such as the Internet.

Browser window 110 may be an instance of a web browser, such as the Microsoft Internet Explorer™ web browser, for example. At any given time, there may be several browser windows in display area 101. A browser window that is last employed by the end-user for navigation is referred to as the “active browser window”. Clicking on any portion of a browser window may bring that browser window into focus.

Browser window 110 may have an address field 112 for indicating the uniform resource locator (URL) address of a computer server serving (i.e., providing content to) browser window 110. The computer server may be a web site, an adserver, or other apparatus for providing content over a network. An end-user may point browser window 110 to a computer server by entering the URL address of the computer server in address field 112. For example, an end-user may point browser 110 to the web site of The Gator Corporation by entering “www.gator.com” in address field 112.

Browser window 110 also has a data area 113 for displaying content. As used in the present disclosure, the term “content” includes texts, programs (e.g., computer-readable program code, hyperlink, scripts), video, graphics, multi-media, pictures and other types of information. On the Internet, an end-user may navigate to various web sites that provide a variety of content, such as educational materials, products available for on-line purchase, news, financial information, and the like. Thus, the type of information that may be displayed in data area 113 is only limited by the imagination of content providers. Browser window 110 may have a title bar 114 for displaying information about the content provider or content being displayed, for example. Browser window 110 may also have pull-down menus 115 for making menu selections, shortcut icons 116 for activating features, and control buttons 117 for minimizing, maximizing, or closing the browser window.

Browser window 110 may share display area 101 with an advertising window 130. Advertising window 130 may be a browser window. As depicted in FIG. 1, advertising window 130 does not include pull-down menus, shortcut icons, and other features normally found in a browser window employed for navigation. It should be understood, however, that advertising window 130 may also be a full-featured browser window, a custom window, or other types of vehicles for presenting information. For example, advertising window 130 may also be a so-called “pop-up” window. Advertising window 130 may display content in data area 131. Advertising window 130 may receive content from a computer server, such as an adserver, for example. Content may be displayed in data area 131 as soon as it is received from the computer server. Content may also be cached in memory (e.g., hard disk or RAM) for later display in data area 131.

A suitable technique for providing content to an advertising window 130 is also disclosed in U.S. application Ser. No. 10/152,204, entitled “METHOD AND APPARATUS FOR DISPLAYING MESSAGES IN COMPUTER SYSTEMS”, filed on May 21, 2002 by Scott G. Eagle, David L. Goulden, Anthony G. Martin, and Eugene A. Veteska, which is incorporated herein by reference in its entirety. Other techniques for providing content to an advertising window may also be employed without detracting from the merits of the present invention.

Advertising window 130 is so named because it is normally employed to display advertising. As used in the present disclosure, the term “advertising” or “advertisement” includes any type of message provided to end-users for the purpose of attracting their attention. Typically, but not necessarily, an advertisement is with regards to a product (i.e., goods or services). However, an advertisement may also be related to an election campaign, a cause (e.g., “save the planet”), an announcement, and the like. On the Internet, advertising serves the same purpose as in other medium, such as radio or television. Advertising helps keep the cost of on-line access down, or free in most situations. Advertising revenues may help defray the cost of developing and maintaining web sites, computer programs, or on-line services, for example.

Because of the nature of windows-based operating systems and the Internet, the content provider for browser window 110 may or may not be the same as the content provider for advertising window 130. In other words, browser window 110 may be served by one computer server while advertising window 130 may be served by another. Rightly or wrongly, some Internet content providers believe that displaying several windows on the same computer screen at the same time may lead to end-user confusion as to content source. Specifically, some content providers argue that displaying advertising window 130 over browser window 110 could make some end-users believe that advertising window 130 and browser window 110 are from the same content provider even though that may not necessarily be the case. In addition, some end-users may not approve of displaying any advertising window over a browser window.

In accordance with an embodiment of the present invention, an advertising window is displayed such that it does not substantially overlap a browser window. Among other advantages, this allows the borders of both windows to be clearly delineated, thereby helping prevent any confusion that may occur with regards to content source. That is, by not obscuring the border of a browser window, content displayed on an advertising window will not be mistaken as originating from the content provider of the browser window. Displaying an advertising window in an area not occupied by other windows is also a “polite” way of displaying advertisements as it does not cover up content that an end-user may be viewing.

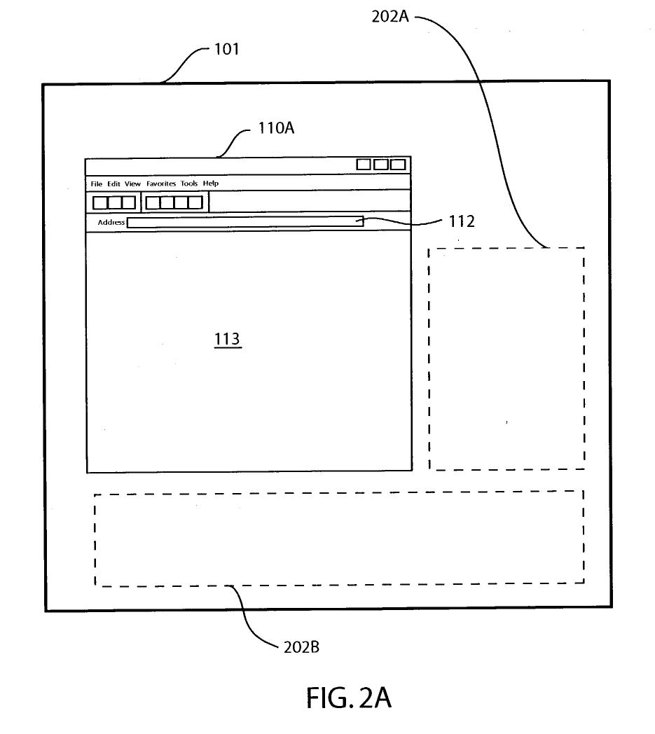

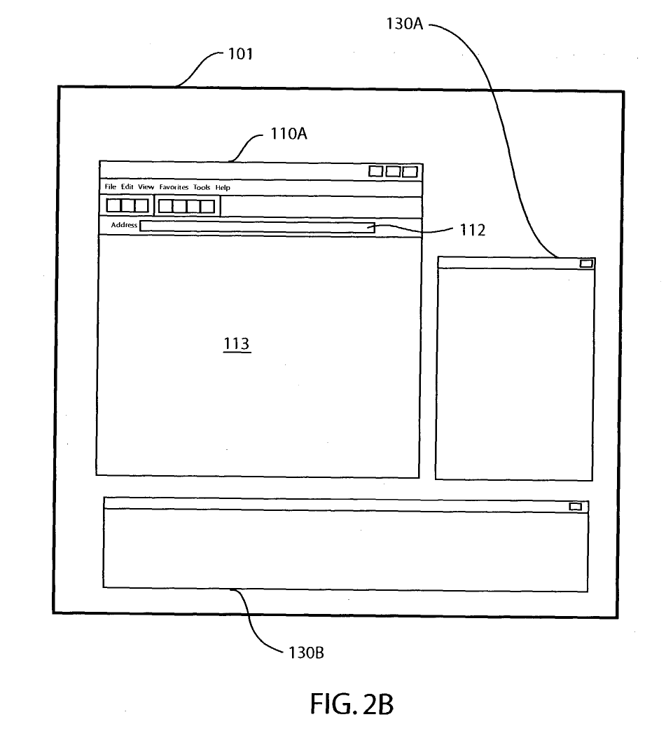

FIGS. 2A and 2B illustrate an embodiment of the present invention where an advertising window is displayed in an available space in a computer screen. Referring to FIG. 2A, there is shown a browser window 110A in display area 101. Browser window 110A is a specific embodiment of browser window 110 shown in FIG. 1. To display an advertising window in display area 101 along with browser window 110A, an embodiment of the present invention determines if there is available space in display area 101. As used in the present disclosure, “available space” refers to an area not occupied by a browser window and has enough space to display an advertising window. Using FIG. 2A as an example, space 202A represents an available space if an advertising window may be displayed in it without substantially overlapping browser window 110A. That is, if an advertising window fits or may be resized to fit in space 202A, space 202A may be deemed as “available space”. The same is true for space 202B.

FIG. 2B shows browser window 110A being displayed along with advertising windows 130A and 130B. Advertising windows 130A and 130B are specific embodiments of advertising window 130 shown in FIG. 1. In FIG. 2B, advertising window 130A fits (or has been resized to fit) in space 202A so as to avoid overlapping browser window 110A. Similarly, advertising window 130B fits (or has been resized to fit) in space 202B. As can be appreciated, displaying advertising windows 130A and 130B such that they do not overlap browser window 110A helps minimize confusion as to the content source of browser window 110A. In addition, advertising windows 130A and 130B are polite in the sense that they may display advertisements without interrupting viewing of browser window 110A.

Note that if there is more than one browser window in display area 101, any one of the browser windows may be used as a reference in determining if there is available space. For example, the active browser window may be employed as the reference. As another example, the browser window that is in focus may be employed as the reference. Yet another example, the browser window displaying content provided by a particular web site (as determined from the URL address indicated in an address field or information in a title bar) may be employed as the reference. Choosing which browser window to be used as a reference will depend on the application. In situations where there are several browser windows in a display area, an advertising window may overlap browser windows not designated as the reference.

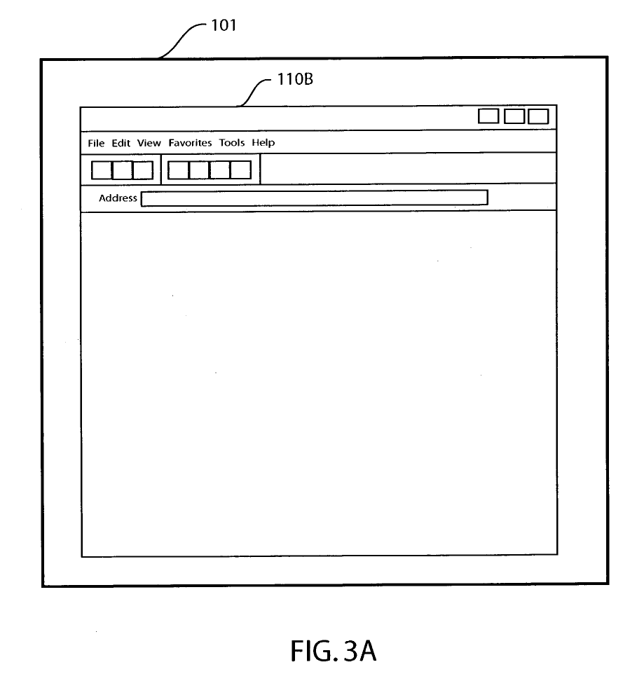

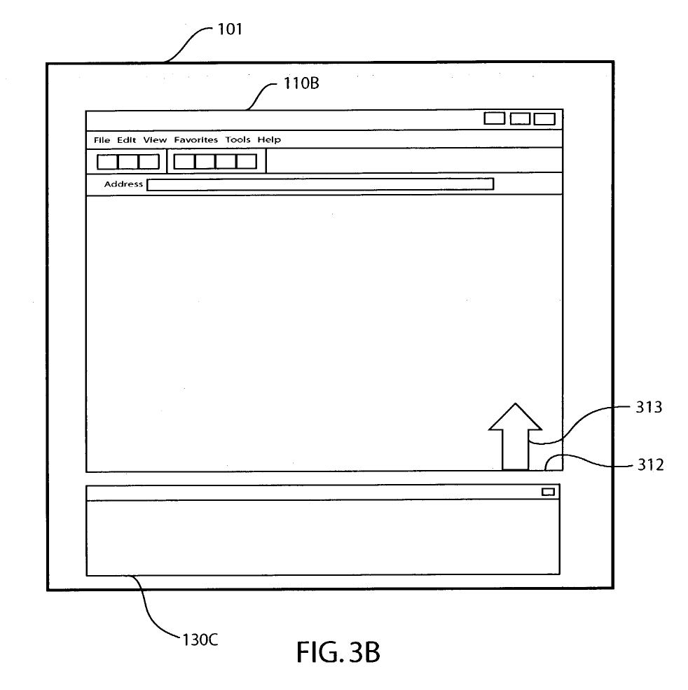

FIGS. 3A and 3B illustrate an embodiment of the present invention where a browser window is reconfigured to make room for an advertising window. In FIG. 3A, a browser window 110B occupies most of display area 101, and does not leave any available space for an advertising window. Browser window 110B is a specific embodiment of browser window 110 shown in FIG. 1.

Turning to FIG. 3B, browser window 110B is reconfigured to make room for an advertising window 130C in accordance with an embodiment of the present invention. Advertising window 130C is a specific embodiment of advertising window 130 shown in FIG. 1. In the example of FIG. 3B, browser window 110B is reconfigured by vertically resizing browser window 110B. Specifically, in the example of FIG. 3B, browser window 110B is reconfigured by cropping its bottom edge portion 312 in the direction indicated by an arrow 313.

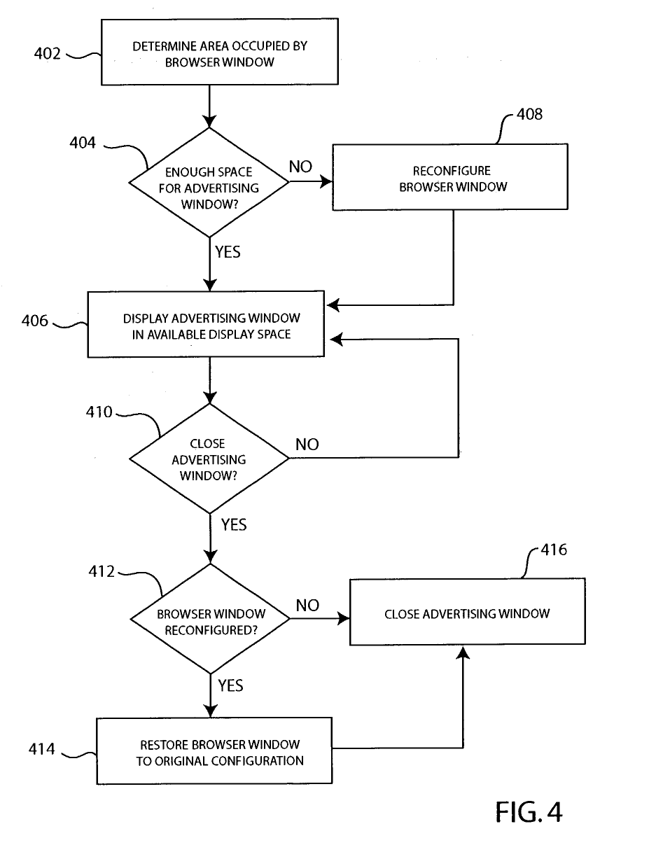

FIG. 4 shows a flow diagram of a method 400 for displaying an advertising window in a networked computer in accordance with an embodiment of the present invention. In light of the present disclosure, those of ordinary skill in the art will appreciate that method 400 may be implemented in software (i.e., computer-readable program code in computer memory), hardware, or a combination of both (e.g., firmware). For example, method 400 may be implemented as a client-side software. Specifically, a client-side software may determine the area occupied by a browser window as indicated in step 402, may determine if there is enough space for an advertising window as indicated in step 404, and so on. The same client-side software may receive content from a computer server over the Internet or other network. For example, a computer server may serve an advertising window displayed as indicated in step 406.

Method 400 is herein described as it may be implemented in the Microsoft Windows™ operating system running in a personal computer coupled to the Internet. It is to be noted, however, that the present invention is not so limited and may also be implemented in other windows-based operating systems. It is to be further noted that the following pseudo-codes do not include information relating to specific data types, use of memory pointers, and other implementation details well known to those of ordinary skill in the art.

Starting in step 402, the area occupied by a browser window in a display area of a computer screen is determined. The area occupied by a browser window may be determined by identifying the browser window among several windows, and then getting the size and location of the browser window. For example, the area occupied by a browser window may be determined as follows:

‘assume browserID is a variable that identifies the browser window

integer browserLeft, browserTop, browserWidth, browserHeight

GetWindowPosition(browserID, browserTop, browserLeft, browserWidth, browserHeight)

‘now left and top identify the top-left position of the window, width and height can be added to determine the covered area

In step 404, it is determined whether there is enough space in the display area to display an advertising window without substantially overlapping the browser window. Whether or not there is available space may be determined by getting the size of the display area, locating the browser window in the display area, and then determining if an advertising window will fit or can be reconfigured to fit anywhere in the display area without overlapping the browser window. For example whether there is enough space in the display area to display an advertising window may be determined as follows:

‘Note that we need to know the size of the end-users screen, this is done through using a system call like . . .

integer screenWidth, screenHeight

GetScreenSize(screenWidth, screenHeight)

‘Assume the size of the advertising window itself is indicated by adWinWidth and adWinHeight

‘Let's see if there's enough room at the bottom of the screen to show the ad window. Assume the origin of the screen (0,0) is the upper left corner of the screen

‘and the origin of all windows is the upper left corner

availScreenHeightBottom=screenHeight−(browserTop+browserHeight)

if (availScreenHeightBottom>=adWinHeight) ‘there's room to display the ad below the browser window else ‘check above browser or to right or left . . .

In step 406, an advertising window is displayed in an available space if there is one. Otherwise, as indicated in step 408, the browser window may have to be reconfigured to make room for the advertising window. The browser window may be reconfigured by resizing the browser window, relocating the browser window, or resizing and relocating the browser window. For example, a browser window may be reconfigured as follows:

‘Assume we want to place the ad at the bottom of the screen and we need to reduce the height of the browser window

‘The amount by which we want to decrease the height is . . . reducedBrowserHeight=browserHeight−(adWinHeight−availScreenHeightBottom)

‘Take off another 10 to put some small amount of space between the two windows

reducedBrowserHeight=reducedBrowserHeight−10

SetWindowPosition((browserID, browserTop, browserLeft, browswerWidth, reducedBrowserHeight)

‘Now the advertising window can be shown at the bottom, left of the screen . . .

SetWindowPosition(adWindowID, 0, screenHeight−adWinHeight,adWinWidth, adWinHeight)

ShowWindow(adWindowID, SW_SHOW)

In steps 410 and 406, the advertising window may remain displayed until a command to close the advertising window is received. A command to close the advertising window may come from a client-side or server-side software, or from an end-user. For example, an end-user may close the advertising window by clicking on a “close” control button (e.g., see control button 118 in FIG. 1) using a mouse or similar pointing device.

If a command to close the advertising window is received and the browser window has been reconfigured, the browser window may be restored back to its original configuration as indicated in step 414. This advantageously makes the advertising window more polite, and hence more transparent to an end-user. The browser window may be restored back to its original configuration as follows:

SetWindowPosition(browserID, browserLeft, browserTop, browserWidth, browserHeight)

In step 416, the advertising window is closed. Note that the advertising window may also be closed before restoring the browser window back to its original configuration.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method of displaying a window in a computer screen, the method comprising:
determining an area occupied by a browser window in a computer screen;
determining if there is an available space in the computer screen based on the area occupied by the browser window; and
if there is an available space in the computer screen, displaying an advertising window in the available space such that the advertising window does not substantially overlap the browser window, the advertising window being configured to receive content over a computer network.

2. The method of claim 1 wherein the advertising window comprises a pop-up window.

3. The method of claim 1 wherein the computer network includes the Internet.

4. The method of claim 1 wherein the browser window is identified as receiving content from a particular content provider.

5. The method of claim 1 further comprising:
if there is no available space in the computer screen, reconfiguring the browser window to make room for the advertising window in the computer screen.

6. The method of claim 5 wherein reconfiguring the browser window includes resizing the browser window.

7. The method of claim 5 further comprising:
if the browser window has been reconfigured, restoring an original configuration of the browser window when the advertising window is to be closed.

8. The method of claim 5 wherein the advertising window comprises a pop-up window.

9. A computer comprising:
computer-readable program code for displaying a browser window in a computer screen;
computer-readable program code for determining if there is an available space in the computer screen to display an advertising window without substantially overlapping the browser window;
computer-readable program code for displaying the advertising window in an available space in the computer screen; and
computer-readable program code for displaying in the advertising window content received over a computer network.

10. The computer of claim 9 wherein the computer network includes the Internet.

11. The computer of claim 9 wherein the advertising window comprises a pop-up window.

12. A computer comprising:
computer-readable program code for displaying a browser window in a computer screen;
computer-readable program code for determining if there is an available space in the computer screen to display an advertising window without substantially overlapping the browser window;
computer-readable program code for reconfiguring the browser window if there is no available space in the computer screen; and
computer-readable program code for displaying an advertising window in an available space that resulted from reconfiguring the browser window, the advertising window being configured to display content received over a computer network.

13. The computer of claim 12 wherein the computer network includes the Internet.

14. The computer of claim 12 wherein the advertising window comprises a pop-up window served by a computer server on the Internet.

15. The computer of claim 12 further comprising:
computer-readable program code for restoring an original configuration of the browser window when the advertising window is to be closed.

16. A method of providing content over a computer network, the method comprising:
providing content to an advertising window over a computer network, the advertising window being displayed in an area of a computer screen that is made available by reconfiguring a browser window.

17. The method of claim 16 wherein the browser window is restored to an original configuration when the advertising window is to be closed.

18. The method of claim 16 wherein the computer network includes the Internet.

19. The method of claim 16 wherein the advertising window comprises a pop-up window.

20. The method of claim 16 wherein the browser window is identified as receiving content from a particular content provider.

21. The method of claim 16 wherein reconfiguring the browser window comprises resizing the browser window.

22. A method of providing content over a computer network, the method comprising:
providing content to an advertising window over a computer network, the advertising window being displayed in an area of a computer screen that has been determined to be an available space where the advertising window may be displayed without overlapping a browser window.

23. The method of claim 22 wherein the computer network includes the Internet.

24. The method of claim 22 wherein the browser window is identified as receiving content from a particular content provider.
